(19) United States
(12) Patent Application Publication
(10) Pub. No.: US 2006/0159536 A1
(43) Pub. Date: Jul. 20, 2006

(54) Device for guiding electric tool operating direction

(76) Inventor: Jian-Hua Pu, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/037,200

(22) Filed: Jan. 19, 2005

(51) Int. Cl. B23B 49/00; B23G 1/00

(52) U.S. Cl. 408/241 G; 408/16

(57) ABSTRACT

A device for guiding electric tool operating direction, which is disposed on an electric tool, and includes: a power supply unit structured from two mutually configured coaxial coils, wherein one of the coils is a fixed coil, and a second coil is attached to a rotating end, alternating voltage is applied to the fixed coil, which induces alternating voltage output in the second coil through electromagnetic induction, thereby providing power to activate a guide to produce an indicator light. Even if an electric tool machine stops working during machining, the guiding indicator light can be still produced as a reference guide for machining.

### BACKGROUND OF THE INVENTION

(a) Field of the Invention

The present invention relates to a device for guiding electric tool operating direction, and more particularly to a device that uses an electromagnetic induction method to produce a power supply for a guide, which is thereby enabled to guide alignment direction for electric tool finishing. Even if an electric tool machine stops working during machining, an optical guide indicator can be still produced as a reference guide for machining.

(b) Description of the Prior Art

Currently, when manufacturing products (furniture, steel windows, and so on) or when decorating, an electric tool is used to cut or drill holes in an unfinished product. When the unfinished product is to be cut or holes drilled therein, a worker first uses a pen or chalk line to draw lines or marks on the unfinished product, and the worker then uses the electric tool to cut or drill holes in the unfinished product using the previously drawn lines or marks to guide him in accurately cutting or drilling holes.

However, during course of cutting or drilling holes using the aforementioned machining method, the worker is generally unable to clearly see the previously drawn lines or marks, which easily results in the worker wrongly cutting or wrongly drilling the unfinished product, and thus causing wastage in unfinished product material.

Hence, some operators install a guide on the electric tool. Referring to U.S. Pat. No. 6,035,575 and Taiwan patent No. M240285, wherein is disclosed installation of a laser indicator light device on a circular electric saw. When the saw is actuated, the laser light draws an indicator light line on a saw blade along a sawing direction that is used to guide direction of electric cutting, thereby enabling the worker to machine the unfinished product by following the guide path indicated by the indicator light line. However, because the two aforementioned cited patents use batteries as a power supply, thus inconvenience is caused when replacing the batteries.

A recent Taiwan patent No. 90221444 uses magnetic field induced current power generator devices respectively installed in reciprocal positions of working and stoppage between a structural portion of a cutting tool and a machine. Furthermore, voltage from output terminals actuate a laser indicator device, which functions to direct an indicator light. However, because of variation in rotating speed of the cutting tool, thus current is unstable, which thereby further results in endangering circuits in the machine. Moreover, when the machine stops working, because of inability to generate power, thus ability to produce the indicator light is also lost.

### SUMMARY OF THE INVENTION

A primary objective of the present invention is to resolve the aforementioned shortcomings. The present invention uses electromagnetic induction to provide a power supply to a guide, thereby eliminating the need to replace batteries to supply power to the guide, and is characterized in that even if an electric tool machine stops working during machining, a guide indicator can be still produced as a reference guide for machining.

In order to achieve the aforementioned objective, a device for guiding electric tool operating direction of the present invention utilizes two coils, wherein when alternating voltage is applied to the first coil, an alternating voltage output is induced in the second coil. Value of the alternating voltage output depends on ratio of windings on the two coils. The first coil is fixed coil, and the second coil coaxially rotates along with a cutting tool. The induced alternating voltage output of the second coil is supplied to an electronic circuit, which after processing provides power to activate the guide, which then emits a laser light for guiding operating direction. Hence, the need to replace batteries to supply power to the guide is eliminated, and, moreover, function to guide alignment direction for electric tool finishing is achieved.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic view of a first embodiment according to the present invention.

FIG. 2 shows a schematic view of a second embodiment according to the present invention.

FIG. 3 shows a schematic view of a third embodiment according to the present invention.

FIG. 4a shows a schematic view of a first example of usage according to the present invention.

FIG. 4b shows a cutaway view of FIG. 4a.

FIG. 4c shows a schematic view of a circular saw blade connected to a circular drilling machine.

FIG. 4d shows a schematic side view of radially arranged induction coils implemented according to the present invention.

FIG. 5 shows a schematic view of a second example of usage of the present invention.

FIG. 6 shows another embodiment of FIG. 5.

### DETAILED DESCRIPTION OF THE PREFERRED EMBODIMENTS

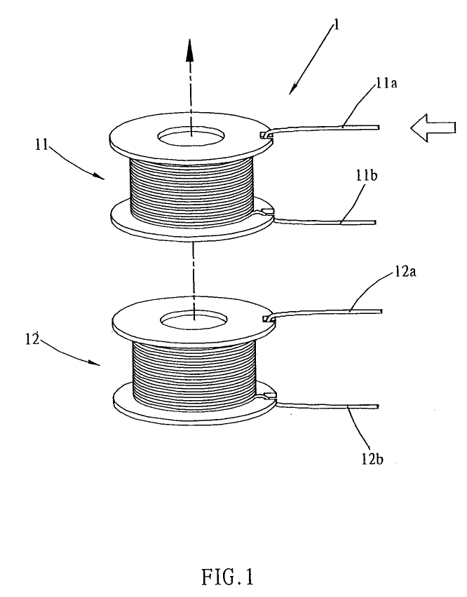

Referring to FIG. 1, which shows a schematic view of a first embodiment according to the present invention, wherein a device for guiding electric tool operating direction primarily comprises a power supply unit 1 that uses an electromagnetic induction method to transmit power, thereby enabling a guide (not shown in FIG. 1), which follows movement of a cutting tool (not shown in FIG. 1), to produce a machining line to guide operating direction of the cutting tool, thus enabling an operator to align cutting with the machining line on an unfinished product.

The aforementioned power supply unit 1 is structured to include a first coil 11 and a second coil 12, which together form an inductor. When alternating voltage is applied to input terminals 11a and 11b of the first coil 11, thus another alternating voltage is induced in the second coil 12 through electromagnetic induction of the inductor, which is output from output terminals 12a and 12b of the second coil 12. Value of the alternating voltage output from the output terminals 12a and 12b depends on input voltage of the first coil 11 and ratio of windings on the two coils 11, 12 (V12=V11 N12/N11), that is, the larger the number of windings (N11) on the first coil 11 or the smaller the number of windings (N12) on the second coil 12, then the smaller the output voltage (V12) of the second coil 12 is. If input voltage (V11) of the first coil 11 is 110 volts, a change in the ratio of windings can reduce voltage range required by the guide (a laser diode module).

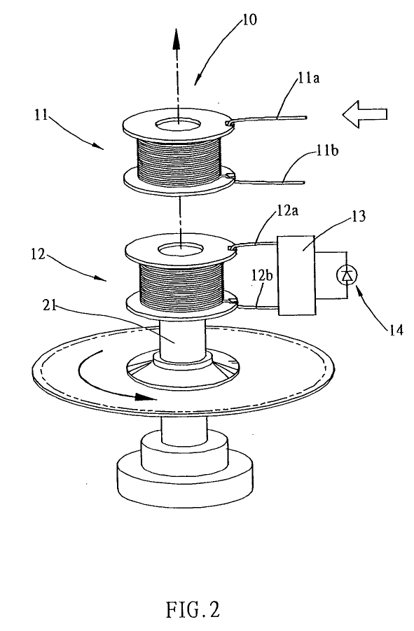

Referring to FIG. 2, which shows a schematic view of a second embodiment of the present invention, wherein axis of symmetry of the first coil 11 and the second coil 12 is along an identical straight line, and the first coil 11 is fixed. The second coil 12, which rotates round a rotating shaft 10, is connected to a cutting tool. Alternating voltage applied to the input terminals 11a and 11b of the fixed first coil 11 induces alternating voltage in the second coil 12, which is output from the output terminals 12a and 12b of the second coil 12 of the rotating shaft 10. The output terminals 12a and 12b of the second coil 12 are connected to an electronic circuit 13, which encompasses either a rectifier or a stabilizer, and a drive circuit, and can commutate or stabilize the alternating voltage output from the output terminals 12a and 12b of the second coil 12, thereby providing at least one guide 14 with a power supply. After the guide 14 has been activated, laser light produced therefrom emits intermittent pulsating light, and as long as the rotating speed is fast enough for the time interval between light pulsations to be shorter than the time the light stays in the human eye, then the light emitted will look as though it is continuous.

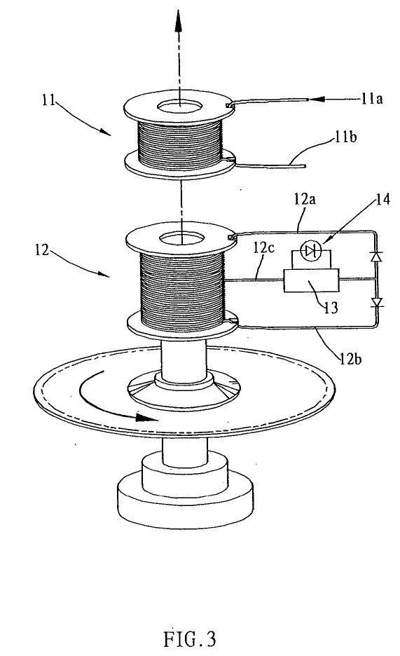

Referring to FIG. 3, which shows a schematic view of a third embodiment of the present invention, wherein a center tapped output terminal 12c extends from a center of the second coil 12. The output terminal 12c connects to the electronic circuit 13 of the guide 14, and transmits a pulsating direct current towards the guide 14, and as long as the rotating speed is fast enough, then there will be no variation in brightness of the light seen by the human eye.

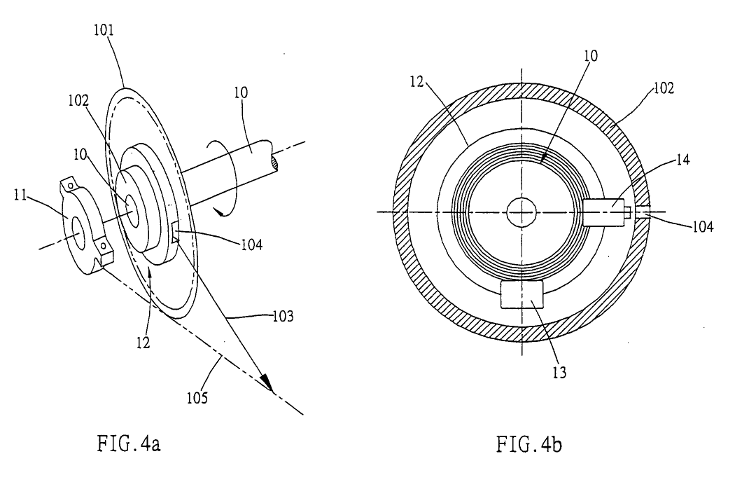

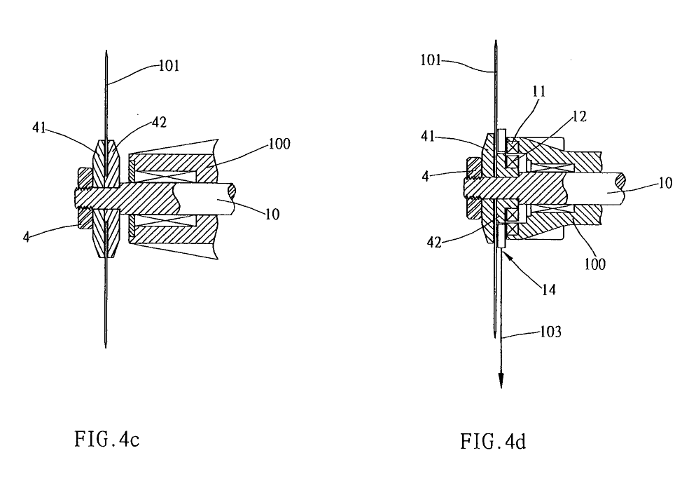

Referring to FIG. 4a and 4b, wherein FIG. 4a shows a cutaway view of a first example of usage of the present invention, wherein the aforementioned guide 14 is utilized to ascertain the operating direction of the tool, for instance, usage on an electric circular saw, wherein a circular saw blade 101 and a laser box 102 are appositionally affixed to the rotating shaft 10 of the circular saw. FIG. 4b shows an internal view of the laser box 102 as seen along direction of the rotating shaft 10. The second coil 12 is disposed so as to encircle the rotating shaft 10, and the fixed first coil 11 is affixed to a casing of the circular saw so as to face the second coil 11. After alternating voltage is applied to the fixed first coil 11, a corresponding alternating voltage is induced in the second coil 12, and power produced by the second coil 12 is first processed by the electronic circuit 13 and then supplied to the guide 14. The light emitted from the guide 14 is then projected onto the unfinished product, thereby forming the machining line for the operating direction.

The aforementioned guide 14 is a laser module containing an optical focusing function that transforms the laser light into a thin beam of light 103. The thin beam of light 103 penetrates a window of the laser box 102 perpendicularly to the rotating shaft 10, and, when rotating, draws a straight line 105 on the saw blade in the cutting direction. The rotating shaft 10 synchronously rotates the guide 14, and thus the laser beam of light 103 emitted from the guide 14 effectuates circumferential scanning. Moreover, scanning frequency satisfies transient retention period of human vision ( 1/18 sec), and thus when cutting along the machining line, the naked eye can view an optical scanning line produced.

If the aforementioned second coil 12 stops working, provided that alternating voltage continues to be supplied to the first coil 11, then the second coil 12 actuates the guide 14 through induction. Conventionally, because the indicator light stops functioning when the cutting tool stops working, thus the magnetic field cutting generator must continue to rotate the cutting tool in order to continue with cutting with guidance from the indicator light.

Referring to FIGS. 4c and 4d, wherein FIG. 4d shows a schematic view of another embodiment of the present invention depicting radially reciprocally arranged induction coils on a shaft portion of an axially rotating cutting tool. Referring first to FIG. 4c, which shows the axially rotating cutting tool, wherein a saw blade 101 of a saw machine is connected to a machine 110. The rotating shaft 10 extends from the machine 110, and a platen 41 and a pallet 42, which are reciprocally coaxial with the rotating shaft 10, are tightly screwed down on an end of the rotating shaft 10 by means of a closure press screw member 4. The pallet 42 abuts against the rotating shaft 10, and the circular saw blade 101 protrudes outwardly through a spacing between the platen 41 and the pallet 42, and is clamped therebetween. Thus, force of pressure from the closure press screw member 4 is transmitted to the rotating shaft 10 through the pallet 42, thereby achieving effective fastening thereat.

Referring again to FIG. 4d, which depicts the other embodiment of the present invention. The reciprocal discal first coil 11 and second coil 12 are radially arranged on the pressed pallet 42 of the circular saw blade 101, and the circular saw blade 101 is tightly connected to the rotating shaft 10 from bracketing of the pallet 42 and the platen 41 fastened down by the closure press screw member 4. The rotating shaft 10 is pin connected to the machine 110 so as to be movably disposed thereon.

The second coil 12 is mounted on a radial circumference of the pallet 42, and the guide 14 is then installed at a position close to the circular saw blade 101. The second coil 12 actuates the guide 14 through induction. The first coil 11 is mounted radially outward from the second coil 12 and affixed to the machine 100. Electric power is supplied by any method.

After alternating voltage is applied to the first coil 11, current produced induces a voltage in the second coil 12, and the induction thus produced enables the guide 14 to emit the indicator light. The aforementioned radial arrangement can be implemented in a variety of machine tools, thereby essentially lowering relative height of the entire induction coil. The first aforementioned embodiment configured with two reciprocally coaxial coils has a total height that is twice as high as the embodiment as depicted in FIG. 4d, wherein the reciprocally radially arranged first coil 11 and second coil 12 reduces relative height of the entire induction coil.

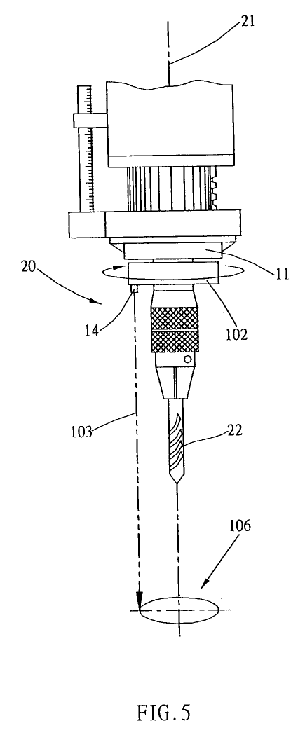

Referring to FIG. 5, which shows a schematic view of a second use of the present invention, wherein a drill 22 and the laser box 102 are co-affixed to a rotating shaft 21 of a drilling machine 21. The rotating shaft 21 actuates the drill 22 and the laser box 102. The first coil 11 is affixed to an immobile member of the drilling machine 20, such as a casing, and the corresponding second coil 12 is mounted within the laser box 102. Alternating voltage applied to the first coil 11 induces a corresponding alternating voltage in the second coil 12, thereby providing functional power to the guide 14. The light emitted from the guide 14 is orientated approximately parallel to the rotating shaft 21. When alternating voltage is applied to the first coil 11, thereby inducing a current in the second coil 12, which, after being processed by the electronic circuit 13, enables the activated guide 14 to emit the thin beam of light 103 that draws an indicator circle 106 in a drilling direction of the drilling machine 20, and position of a center of the indicator circle 106 is appositional with that of drilling.

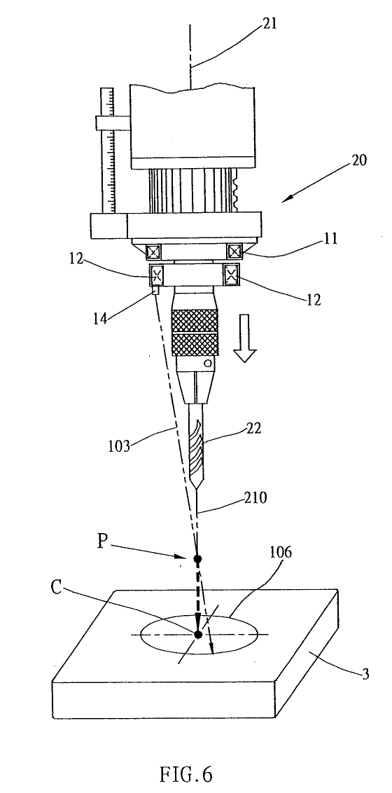

Referring to FIG. 6, which shows implementation of the present invention in the drilling machine 20, wherein the beam of light 103 emitted by the guide 14 obliquely crosses a drilling line 210 of the drill 22. The current induced in the second coil 12 by the first coil 11 actuates the guide 14. After the guide 14 and the drill 22 are synchronously actuated, a focal point P is formed at a position where the emitted beam of light 103 obliquely crosses the drilling line 210, and position of the focal point P is directly below a central point of the drill 22. During course of operating the drilling machine 20, the optical focal point P will synchronously move along with downward displacement of the drill 22, and upon reaching a surface of the unfinished product 3, the focal point P aligns with a processing center C, thereby achieving a guiding reference for drilling an accurate center.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A device for guiding electric tool operating direction, which is disposed on an electric tool, and produces an operating guide direction on an unfinished product; the device for guiding electric tool operating direction comprises:
a power supply unit structured from two reciprocally coaxial coils, wherein one of the coils is a fixed first coil, and the other coil is a second coil; alternating voltage is applied to input terminals of the first fixed coil, which induces alternating voltage in the second coil through electromagnetic induction, and the alternating voltage is output from output terminals of the second coil;
an electronic circuit connected to the output terminals of the rotating second coil, which is used to process the alternating voltage output from the rotating second coil; and
a guide connected to an output terminal of the electronic circuit, which provides a power supply that activates the guide after processing the alternating voltage from the second coil, thereby producing the guide operating direction.

2. The device for guiding electric tool operating direction as described in claim 1, wherein the coils are inductors.

3. The device for guiding electric tool operating direction as described in claim 1, wherein the electronic circuit is either a commutator or a stabilizer.

4. The device for guiding electric tool operating direction as described in claim 1, wherein the guide is a laser diode module.

5. The device for guiding electric tool operating direction as described in claim 1, wherein the rotating second coil, the electronic circuit and the guide are encased in same casing to form a laser box.

6. The device for guiding electric tool operating direction as described in claim 5, wherein the fixed coil is affixed to an immobile member of an electric tool, and positionally faces the second coil 12 mounted within the laser box,
the laser box rotates along with a rotating portion of the electric tool, and the laser box scans an optical indicator line using a scanning light emitted from the laser box.

7. A device for guiding electric tool operating direction, which is disposed on an electric tool, and produces an operating guide direction on an unfinished product; the device for guiding electric tool operating direction comprises:
a power supply unit structured from two reciprocally coaxial coils, wherein one of the coils is a fixed first coil, and the other coil is a second coil; alternating voltage is applied to input terminals of the first coil, and the device uses electromagnetic induction to induce alternating voltage in center tapped output terminals of the second coil;
an electronic circuit connected to the center tapped output terminals of the rotating second coil, which is used to process the alternating voltage output from the rotating second coil; and
a guide connected to an output terminal of the electronic circuit, which provides a power supply that activates the guide after processing the alternating voltage from the second coil activates the guide, thereby producing the guide operating direction.

8. A device for guiding electric tool operating direction, which provides machining guide direction for a drilling machine, comprising a power supply unit that includes an immobile first coil and a coaxial rotating second coil disposed on the drilling machine, wherein the first coil induces a current in the second coil, which activates a guide after passing through an electronic circuit, the guide rotates synchronously with a drill, and a beam of light produced is projected towards a surface of an unfinished product, whereon an indicator circle is scanned.

9. The device for guiding electric tool operating direction as described in claim 1, wherein the beam of light produced by the guide crosses line of drilling of the drill.
